(19) United States
(12) Patent Application Publication
(10) Pub. No.: US 2004/0231104 A1
(43) Pub. Date: Nov. 25, 2004

(54) Door hinge comprising an integrated continuously variable braking and retaining unit

(76) Inventor: Jost Kingelhofer, Remscheid (DE)

Correspondence Address: Steven L Oberholtzer, Brinks Hofer Gilson & Lione, P O Box 10396, Chicago, IL, 60610, US

(21) Appl. No.: 10/480,714

(22) PCT Filed: May 23, 2002
(86) PCT No.: PCT/EP02/05681

(30) Foreign Application Priority Data
Jun. 11, 2001 (DE) 101282559

(51) Int. Cl. E05D 11/08

(52) U.S. Cl. 16/342

(57) ABSTRACT

The invention relates to a door hinge comprising an integrated continuously variable braking and retaining unit, especially a motor vehicle door hinge of the type where the hinge pin hinging the two hinge halves together consists of a full material and is mounted in tho gudgeon of the other hinge half with a non-rotating fit. The hinge further cooperates in sections with at least one of the gudgeons of the other hinge half in which it is that radially project from the hinge axis and that are alternately formed on the hinge pin and in the gudgeon so as to generate a force braking the hinge. The aim of the invention is to reduce the time required for manufacturing such a hinge as it is unacceptable for series production. To this end, a bore (18) that is concentric relative to the hinge axis (24) is lined with a bushing (19) in at least one of the gudgeons (10) of the other hinge half (2) in which the hinge pin (3) is mounted with a running fit. In said bushing, a projection (26) that is radial with respect to the hinge axis (24) is provided across a height that is smaller than the gudgeon height and a corresponding longitudinal section of the hinge pin (3) is provided with a complementary radial projection (23).

### CROSS REFERENCE TO RELATED APPLICATION

This application claims priority to DE 101 28 255.9 filed Jun. 11, 2001 and PCT/EP02/05681 filed May 23. 2002.

### BACKGROUND AND SUMMARY OF THE INVENTION

The invention relates to a door hinge equipped with an integrated braking and holding device, in particular a motor vehicle door hinge of that type in which the hinge pin connecting the two hinge halves pivotably to one another and consisting of a solid material is secured fixedly in terms of rotation in the pin journal or pin journals of one hinge half and cooperates preferably continuously adjustably, so as to generate a resisting torque or braking force, with at least one of the pin journals of the other hinge half, in which it is mounted with a running fit, at least partially by means of shaped portions formed alternately on the hinge pin and in the pin journal and axially parallel to the hinge axis.

DE-A-44 06 824 discloses a door hinge, in particular a motor vehicle door hinge of the abovementioned type, equipped with an integrated braking and holding device, in which the hinge pin connecting the two hinge halves pivotably to one another and consisting of a solid material is secured fixedly in terms of rotation in the pin journal or pin journals of one hinge half and cooperates, so as to generate braking force, with the pin journal or pin journals of the other hinge half, which said hinge pin passes through with bearing play, by means of alternately formed shaped portions.

In this known type of door hinges, the desired resisting torque and holding function, which opposes a progressively increasing resistance to the further opening movement of the motor vehicle door when a predetermined permitted opening angle of the door is exceeded, is generated in that the hinge pin and the pin journal are equipped, over at least a part region of their outer and inner circumference respectively, alternately with a wedge surface which ascends radially at a low angle, and, in which both wedge surfaces must have absolutely identical gradients over their entire overlap region, in order to achieve the desired braking and holding function.

Because its braking and holding function can be achieved only when two wedge surfaces lie one on the other areally over their entire overlap region, the production of a door hinge so equipped requires practically tolerance-free machining and hence an outlay, unacceptable in series production, in terms of the machining both of the pin journal bore and of the hinge pin surface, thus entailing the disadvantage that such tolerance-free manufacture is not possible or at least is totally uneconomic in series production.

DE-U-76 16 362 discloses another type of door hinge equipped with a braking and holding function distinguished characteristically in that, there, the braking and holding forces are applied by means of a resiliently elastic deformation of one pin journal having an oval inner circumference and, for this purpose, the pin journal has to be slotted axially. Braking or holding forces capable of being applied by means of a resiliently elastic deformation of an axially slotted pin journal or else by other spring means may be sufficient, at most, for keeping open furniture doors or furniture flaps, but not at all sufficient for fixing motor vehicle doors. Furthermore, door hinges with a slotted pin journal basically cannot be used in motor vehicle doors because of the risk of the penetration of dirt and the like into the hinge mounting.

In another type of door hinges equipped with an integrated braking and holding device, according to U.S. Pat. No. 3,000,049 (C. S. Terry, Jr.) the use of plastic moldings is provided, so that these hinges, apart from having a special method of production, are distinguished in that the hinge pin stub penetrating into the pin journals of one hinge half and belonging to the other hinge half are provided with radially projecting noses which are each assigned a cooperating feature in the pin journal of the one hinge half, in such a way that the two hinge halves are positively locked relative to one another at least in the fully open and fully closed position of the hinge.

Such an embodiment of a braking and holding device can be employed only in hinges consisting of a plastic material and, furthermore, can be used only for relatively lightweight doors or flaps, for example on furniture.

Door hinges of the prior art designs are equipped with an integrated braking and holding device have in common the fact that either the forces capable of being applied by the integrated braking and holding device are entirely insufficient particularly for the use of the hinge as a motor vehicle door hinge or else, because of the tolerances to be adhered to with regard to the required absolute uniformity both of the forces and of the starting points, series production is either not possible or else entails an absolutely unjustifiable outlay.

The object on which the invention is based is therefore to provide a door hinge, in particular a motor vehicle door hinge with an integrated braking and holding function, which, on the one hand, fulfils the requirement of ensuring a resistance-free opening and closing movement of the door over predetermined permitted opening angles and, on the other hand, fulfils the requirement of opposing sufficiently high and as far as possible progressively growing resistance to the further opening movement of the door in the region of at least one selected opening angle, but at the same time a narrow-tolerance production of the parts of the braking and holding device which cooperate with one another may be dispensed with.

This object is achieved according to the invention in that, in at least one of the pin journal of the other hinge half in which the hinge pin is mounted with a running fit, a bore concentric to the hinge axis is lined with a bushing, in which a hinge pin having a diameter decreasing in step form toward its free end is received, which has, in a portion having a smaller height, as compared with the entire pin journal height, a shaped portion directed radially with respect to the hinge axis, and which is assigned a corresponding length portion of the hinge pin with a complementary radial projection. Accommodating the pin journal's shaped-out portion cooperating with the projection or in any case with a profiling of a length portion of the hinge pin in a bushing capable of being produced independently of the hinge half receiving it makes it unnecessary, in the first place, to have expensive machining of the pin journal of the hinge half. Furthermore, the use of a bushings affords a possibility for an adjustment, independent of the actual pin journal bore, of the position or of the door opening angle at which the braking and/or holding force is to commence, in particular by virtue of the subsequent aligned securing of the bushing within the pin journal bore. In particular, there is expediently provision for the profilings, cooperating with one another to apply the braking and holding forces, of the bushing bore and of the hinge pin to be aligned with one another, for example to be aligned with the start of a braking or fixing function, before the bushing is pressed into the pin journal of the other hinge half in a position corresponding to a defined door opening angle.

In summary, the invention thus shows a way of shifting the precision necessary for the uniform commencement of the braking and holding action, even in series manufacture, away from the machining of the pin journal bore, in particular, and toward a setting operation, thus eliminating the disadvantage, inherent in previous proposals, of an unacceptable outlay in production terms.

In particular, there may be provision for the bushing to have provided in it a shaped-portion offset radially axially parallel to the hinge axis and for the hinge pin to have provided on it a length portion offset radially correspondingly axially parallel with respect to the hinge axis, while, in a selected case, the shaped portion provided in the bushing through which the hinge pin passes with a running fit may have a circular cross-sectional shape and the associated length portion of the hinge pin may have a cylindrical shape.

In a modified embodiment, however, there may also be provision for the shaped portion provided in the bushing through which the hinge pin passes with a running fit to have a cross-sectional shape deviating from a pure circular shape and for the associated length portion of the hinge pin to have a three-dimensional shape deviating from a pure cylindrical shape.

When the hinge halves are in a mutual position corresponding to a predetermined door opening angle, the bushing is secured with respect to its radially offset shaped portion in the pin journal nonpositively and/or positively in a relative position, corresponding to the desired or intended start of the braking or holding force, in relation to the radially offset length portion of the hinge pin, and, for securing the bushing fixedly in terms of rotation, the pin Journal receiving said bushing is provided with a recess and said bushing is provided with a complementarily configured deformable region, in particular a radially projecting collar, which can be brought into positive engagement with the recess of the pin journal.

To produce a door hinge, in particular a motor vehicle door hinge, equipped with an integrated braking and holding device, there may be provision, in a first method according to the invention, that two hinge halves are produced and one of the two hinge halves is equipped with a hinge pin equipped in a previous operation with a radial projection suitable for generating a braking and holding force and the other of the two hinge halves is equipped with an, in particular, cylindrical pin journal bore possessing oversize with respect to the hinge pin, and that, in a further operation, a bushing provided with a radial shaped portion complementary to the radial projection of the hinge pin is produced and is first inserted loosely into the pin journal bore of the other hinge half, and, in a further method step, the hinge pin connected fixedly in terms of rotation to the one hinge half is introduced into the bushing and is rotated with respect to the latter until the commencement of a braking and/or holding force, and that, finally, the bushing is secured, in the pin Journal of the other hinge half, in a rotary position corresponding to the intended commencement of the braking or holding force assigned to a defined door opening angle.

In a second method according to the invention, however, with regard to the production of a door hinge, in particular a motor vehicle door hinge, equipped with an integrated braking and holding device, there may also be provision that the bushing is placed onto the hinge pin and rotated with respect to the latter until the start of a braking or holding force and is subsequently pressed, in this relative position in relation to the hinge pin, into the pin journal of the other hinge half, the other hinge half being aligned with the one hinge half in a position corresponding to the intended start of a braking and/or holding force assigned to a defined door opening angle.

### BRIEF DESCRIPTION OF THE DRAWINGS

The invention is described in detail in the following example description with reference to an exemplary embodiment illustrated in the drawing in which:

FIG. 1 shows a longitudinal section through a motor vehicle door hinge equipped with an integrated braking and holding device, in the case of a hinge which is in a free-motion position;

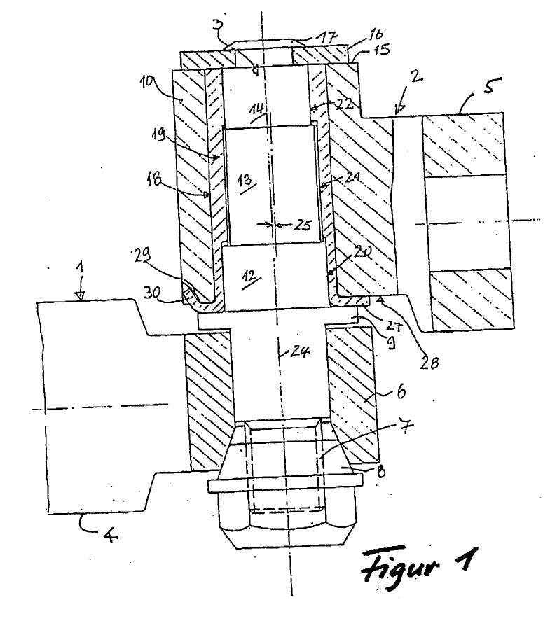

FIG. 2 shows a longitudinal section through a motor vehicle door hinge according to FIG. 1 equipped with an integrated braking and holding device, in the case of a hinge located in a braking or holding position;

FIG. 3 shows a cross section through the hinge illustration according to FIG. 1 along the line III-III;

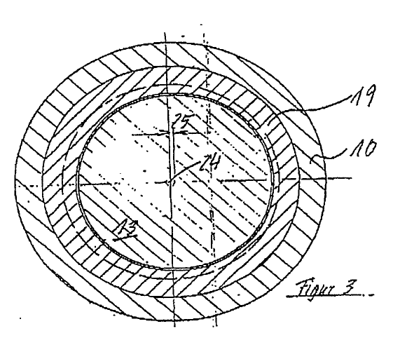

FIG. 4 shows a cross section through the hinge illustration according to FIG. 2 along the line IV-IV.

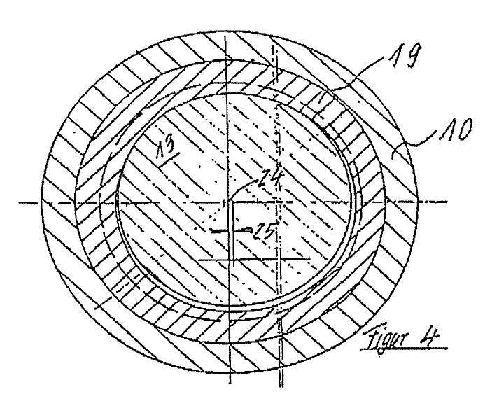

### DETAILED DESCRIPTION OF THE INVENTION

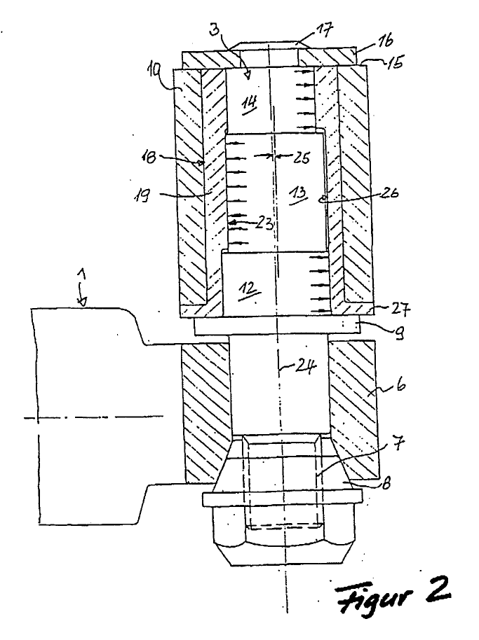

The motor vehicle door hinge illustrated in the drawing and equipped with an integrated braking and holding function comprises, as basic components, a first 1 and a second 2 hinge half and also a hinge pin 3 connected fixedly in terms of rotation to the first hinge half 1. The first hinge half 1 is equipped with a hinge leaf 4 and the second hinge half 2 with a hinge leaf 5, via which the first 1 and the second 2 hinge halves are connected to a door arrangement part, door or door column, not illustrated in detail in the drawing. The hinge pin 3 is secured with a firm fit in the pin journal 6 of the first hinge half 1, for example by means of the screw connection consisting of the threaded portion 7 and of the conical nut 8. Furthermore, the hinge pin 3 is provided with a radially projecting rim 9, via which it engages, with the hinge assembled, between the mutually confronting joining surfaces of the pin journals 6 and 10 of the two hinge halves 1 and 2. Over its length region passing through the pin journal 10 of the other hinge half 2, the hinge pin 3 is provided with steps 12, 13 and 14 decreasing in diameter toward its free end 11. The hinge pin 3 is secured in the axial direction against axial creep with respect to the hinge half 2 by means of an abutment washer 16 lying on its outer joining surface 15 and by means of a rivet head 17 engaging over said abutment washer. As is evident, in general, from the drawing, the pin journal 10 of that hinge half 2 in which the hinge pin 3 has a running fit has a pin journal bore 18 which possesses oversize with respect to the hinge pin 3 and is continuous with a smooth surface and which receives a bushing 19. The bushing 19, with its outer circumference designed cylindrically with a smooth surface, is equipped on the inside with diameter steps 20, 21 and 22 corresponding to the steps 12, 13 and 14 of the hinge pin 3. The hinge pin 3 is equipped over its diameter step 13 with a radial projection 23 which, according to the illustration in FIG. 2, is formed by a cylindrical portion arranged so as to be offset axially parallel by an offset 25 to the hinge axis 24. Complementarily to the projection 23 of the hinge pin 3, the bushing 19 is equipped over the region with a gap 26 arranged so as to be radially offset to the hinge axis 24, in such a way that, according to the illustration in FIG. 2, the radial projection 23 of the hinge pin 3 can come into engagement with the associated step 21 of the bushing 19 solely over an intended door opening angle.

In the embodiment shown, the bushing 19 is designed as a collared bushing, said bushing engaging with its collar 27 between the rim 9 of the hinge pin 3 and the inner joining surface 28 of the pin journal 10 of the other hinge half. For the, in particular, positive securing of the bushing 19 with respect to the pin journal 10, the pin journal 10 has provided in it a radially directed recess 29, into which a portion of the collar 27 of the bushing can be snapped, preferably at the same time with inductive heating.

As regards the method for assembling a door hinge equipped with such an integrated braking and holding device, there is provision, in one of a plurality of methods which are possible according to the invention, that two hinge halves 1 and 2 are produced in succession and one of the two hinge halves 1 and 2 is equipped with a hinge pin 3 equipped in a previous operation with a radial projection 23 suitable for generating a braking and holding force, and the other of the two hinge halves 1 and 2 is equipped with an, in particular, cylindrical pin journal bore 18 possessing oversize with respect to the hinge pin 3, and that, in a further operation, a bushing 19 provided with a radial gap portion 26 complementary to the radial projection 23 of the hinge pin 3 is produced, and that, further, the bushing 19 is placed onto the hinge pin 3 and rotated with respect to the latter until the start of a braking or holding force and is subsequently pressed, in this relative position in relation to the hinge pin 3, into the pin journal bore 18 of the pin journal 10 of the other hinge half 2, the other hinge half 2 being aligned with the one hinge half 1 in a position corresponding to the intended start of a braking and/or holding force assigned to a defined door opening angle.

While the above description constitutes the preferred embodiment of the present invention, it will be appreciated that the invention is susceptible to modification, variation and change without departing from the proper scope and fair meaning of the accompanying claims.

1. A motor vehicle door hinge equipped with an integrated braking and holding device, comprising a first hinge halve, a second hinge halve, each having respective first and second pivot journals,
a bushing installed in the second pivot journal,
a pivot pin being formed of a solid material fixedly installed within the first pivot journal and within the bushing of the second pin journal, pivotably connecting the first and second hinge halves,
the pivot pin interacting with the bushing to provide a braking torque against relative rotation between the first and second hinge halves, and
the hinge pin having a diameter decreasing in step form including a first step and a second step toward a free end, the second step having a smaller height as compared with the entire height of the bushing, the second step of the hinge pin having a radial projection directed radially with respect to the axis of the hinge pin, the radial projection engaging with the bushing to provide the braking torque when the first and the second hinge halves are rotated relative to one another in a predetermined rotated position.

2. The door hinge as claimed in claim 1, further comprising the bushing has provided in it a shaped portion offset radially axially parallel to the hinge axis and positioned at the position of the radial projection of the hinge pin.

3. The door hinge as claimed in claim 2, further comprising that the shaped portion provided in the bushing through which the hinge pin passes with a running fit has a circular cross-sectional shape.

4. The door hinge as claimed in claim 2, further comprising that the shaped-out portion provided in the bushing through which the hinge pin passes with a running fit has a cross-sectional shape deviating from a pure circular shape.

5. The door hinge as claimed in claim 1 further comprising that the axially parallel radially offset portion of the hinge pin has a cylindrical shape.

6. The door hinge as claimed in claim 1 further comprising that the axially parallel radially offset portion of the hinge pin has a three-dimensional shape deviating from a pure cylindrical shape.

7. The door hinge as claimed in claim 2, further comprising that the bushing is secured with respect to the radially offset shaped-out portion nonpositively in a relative rotated position, corresponding to the desired start of the braking or holding force, in relation to the radially offset portion of the hinge pin.

8. The door hinge as claimed in claim 2, characterized in that the bushing is secured with respect to the radially offset shaped-out portion positively in a relative rotated position, corresponding to the desired start of the braking or holding force, in relation to the radially offset portion of the hinge pin.

9. The door hinge as claimed in claim 1, further comprising that, for securing the bushing fixedly to the second pin journal in terms of rotation, the second pin journal is provided with a recess, and the bushing is provided with a complementarily configured deformable collar, which can be brought be deformation into positive engagement with the recess.

10. A method for producing a door hinge equipped with an integrated braking and holding device, in particular a motor vehicle door hinge characterized in that two hinge halves are produced and one of the two hinge halves is equipped with a hinge pin having a radial projection suitable for generating a braking and holding force and the other of the two hinge halves is equipped with an, in particular, cylindrical pin journal bore possessing oversize with respect to the hinge pin, and in that, in a further operation, a bushing is provided with a radial shaped-out portion complementary to the radial projection of the hinge pin is produced and is first inserted loosely into the pin journal bore of the other hinge half, and, in a further method step, the hinge pin connected fixedly in terms of rotation to the one hinge half is introduced into the bushing and is rotated with respect to the latter until the commencement of a braking and/or holding force, and in that, finally, the bushing is secured, in the pin journal of the other hinge half, in a rotary position corresponding to the intended commencement of the braking or holding force assigned to a defined door opening angle.

11. A method for producing a door hinge equipped with an integrated braking and holding device, in particular a motor vehicle door hinge, in which, in succession, two hinge halves are produced and one of the two hinge halves is equipped with a hinge pin equipped in a previous operation with a radial projection suitable for generating a braking and holding force, and the other of the two hinge halves is equipped with an, in particular, cylindrical bore possessing oversize with respect to the hinge pin, and in that, in a further operation, a bushing is provided with a radial shaped-out portion complementary to the radial projection of the hinge pin, characterized in that the bushing is placed onto the hinge pin and rotated with respect to the latter until the start of a braking or holding force and is subsequently pressed, in this relative position in relation to the hinge pin, into the pin journal bore of the other hinge half, the other hinge half being aligned with the one hinge half in a position corresponding to the intended start of a braking and/or holding force assigned to a defined door opening angle.
